(19) United States
(12) Patent Application Publication
(10) Pub. No.: US 2013/0201281 A1
(43) Pub. Date: Aug. 8, 2013

(54) OPTICAL DEVICE FOR CAPTURING IMAGES ACCORDING TO A 360° FIELD

(71) Applicants: Richard Ollier, Lille (FR); José Costa, Lille (FR)

(72) Inventors: Richard Ollier, Lille (FR); José Costa, Lille (FR)

(73) Assignee: GIROPTIC, Lille (FR)

(21) Appl. No.: 13/821,713

(22) PCT Filed: Sep. 8, 2011
(86) PCT No.: PCT/FR2011/000495

§ 371 Date: Apr. 12, 2013

(30) Foreign Application Priority Data
Sep. 9, 2010 (FR) 10/03599

(51) Int. Cl. H04N 5/232

(52) U.S. Cl. CPC H04N 5/23238
USPC 348/36

(57) ABSTRACT

An optical device (1) is described for capturing images, in a 360° field, by digital stitching of three images. The device includes three optical groups (2, 3, 4) having a longitudinal axis (20, 30, 40) for obtaining the three images. Each optical group (2, 3, 4) includes a head lens (21, 31, 41) followed by several lenses (211, 311, 411) on the same longitudinal axis (20, 30, 40) to project rays towards an image sensor (22, 32, 42). The three optical groups (2, 3, 4) are interlinked around an imaginary axis of rotation (5), and positioned to overlap in a triangular configuration, in the direction of the imaginary axis of rotation, the longitudinal axes (20, 30, 40) being inclined with respect to a plane orthogonal to the imaginary axis of rotation to allow the interlinking of the optical groups.

The invention relates to an optical device for capturing images according to a 360° field, by digital stitching of three images.

In the field of image capture, acquiring a 360° field by juxtaposition and digital stitching of several images obtained by means of several lenses is known.

Thus cameras are known comprising several lenses distributed around a sphere and enabling images to be acquired at different angles of view.

Such cameras are for example used, fixed to vehicles, in order to film streets and other places while driving. Such a known camera comprises eleven lenses regularly distributed over a sphere for image acquisition according to eleven points of view. These eleven images can then be juxtaposed and undergo digital processing in order to reconstitute the optical field according to 360°.

Such a camera has proved its effectiveness during the creation of maps but is, through its bulk and cost, little suited to other general public applications.

The aim of the present invention is to overcome the aforementioned drawbacks by proposing a device for image capture according to a 360° field, particularly compact and of low cost price.

Another aim of the invention is to propose such a camera with several lenses affording good juxtaposition of the images taken during the digital stitching step.

Another aim of the invention is to propose a portable device that is simple to use.

Other aims and advantages of the present invention will emerge during the following description, which is given only by way of indication and has no limitative purpose.

Thus the invention concerns an optical device for image capture, according to a 360° field, by digital stitching of three images, comprising three lenses with a longitudinal axis for the respective acquisitions of said three images, each optical group having a head lens followed, on the same optical axis of said optical group, by several lenses in order to project the rays transmitted to an image sensor, said three groups being entangled together about an imaginary rotation axis for them, and in which, in the direction of said imaginary rotation axis, the optical groups are positioned overlapping in a triangular geometric configuration, the longitudinal axis of each optical group being inclined with respect to a plane orthogonal to said imaginary rotation axis so as to enable said optical groups to be entangled.

The invention will be better understood from a reading of the description accompanied by the appended figures, among which:

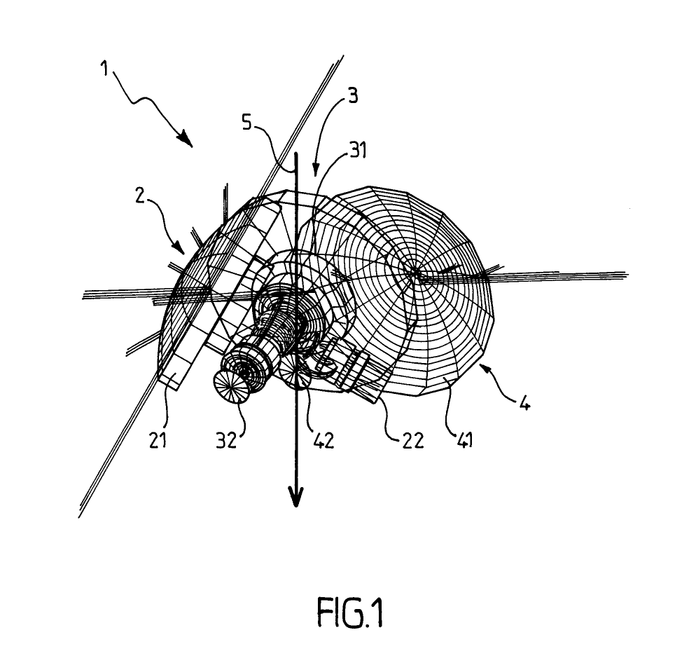

FIG. 1 is a view of an assembly of lenses of a device according to the invention according to one embodiment.

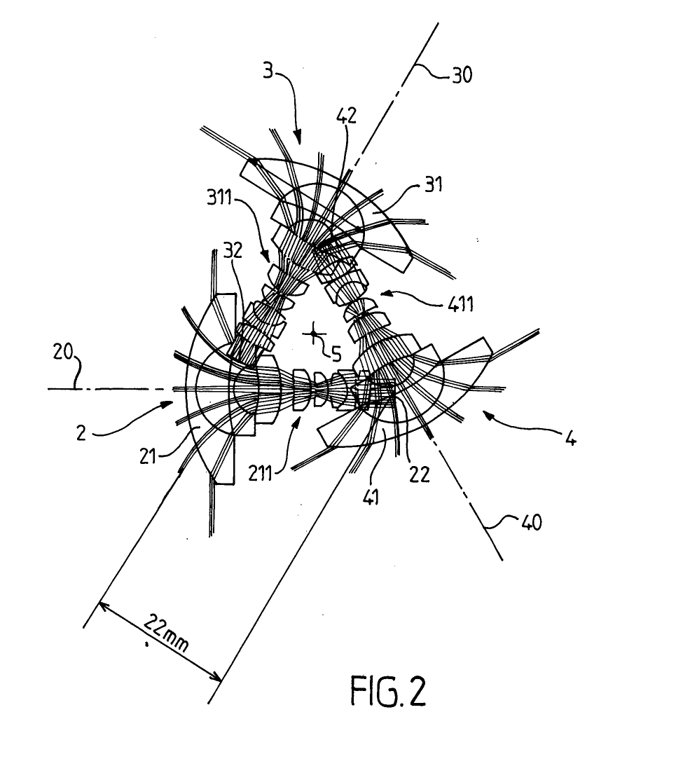

FIG. 2 is a plan view of the assembly of lenses as illustrated in FIG. 1.

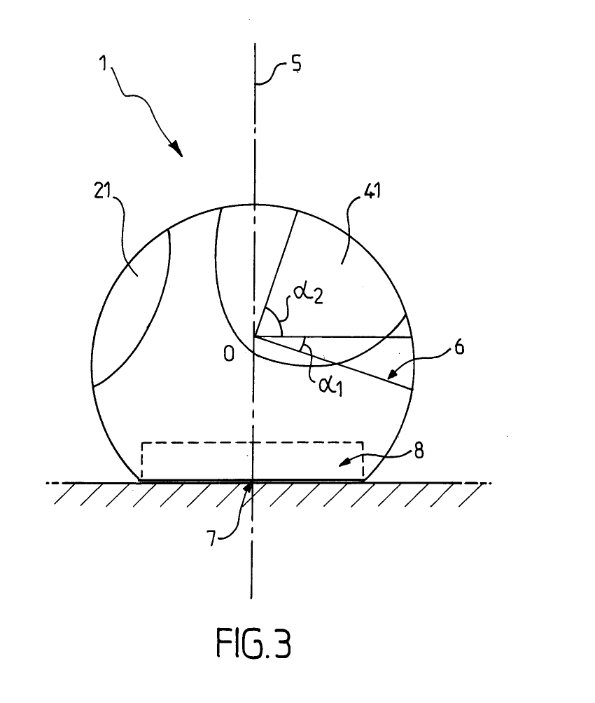

FIG. 3 is a view of the device as illustrated in FIG. 1, the assembly of lenses being housed in a casing resting, by means of a flat face, on a horizontal surface while positioning the imaginary rotation axis vertically.

Thus the invention concerns an optical device 1 for image capture, according to a 360° field, by digital stitching of three images. The optical device thus comprises three optical groups 2, 3, 4, with a longitudinal axis 20, 30, 40, for the respective acquisitions of said three images.

Each optical group 2, 3, 4 has a head lens 21, 31, 41, followed on the same longitudinal axis 20, 30, 40 by the optical group with several lenses 211, 311, 411 in order to project the rays transmitted to an image sensor 22, 32, 42. The image sensors may be digital sensors, in particular CCDs, for example of the 7 million pixel type.

Advantageously, the three optical groups are entangled with each other about an imaginary rotation axis 5 for said groups, the longitudinal axis 20, 30, 40 of each optical group being inclined with respect to a plane orthogonal to said imaginary rotation axis 5 so as to enable the optical groups to be entangled.

Imaginary rotation axis means the fact that the position of one of the three optical groups 2, 3, 4 can be obtained from one of the other two optical groups of the devices after a rotation transformation in space having as its axis said imaginary rotation axis 5.

According to the invention, it is thus possible to reconstitute the optical field over 360° by juxtaposition of three images. To this end, only the three optical groups of the device are necessary.

Advantageously, the entanglement makes it possible to bring these lenses close to each other and thus to bring the nodal points of each lens close to each other, affording better juxtaposition of the three images during the stitching step.

The field can thus be collected at 360° around said imaginary axis 5, the elevation of the optical field being able to extend between a strictly negative angle α₁, such as for example −20°, and a strictly positive angle α₂, such as for example +70°.

The head lens 21, 31, 41 by means of which the light enters may be a wide-angle lens as illustrated in FIG. 2 in particular. This lens is followed by several lenses that can make it possible to project the transmitted rays to the image sensor 22, 32, 42, while limiting to the distance between the head lens 21, 31, 41 and the image sensor 22, 32, 42. In addition, these lenses 211, 311, 411 can be chosen in order to correct astigmatism and field curvature.

As illustrated according to FIG. 2, the relative positions of the three optical groups 2, 3, 4 can be obtained by successive rotations through 120°, along said imaginary rotation axis 5.

This angle of inclination between the longitudinal axis 20, 30, 40 of each optical group 2, 3, 4 and the plane orthogonal to said imaginary rotation axis 5 can be between 15° and 30° in particular.

Thus, as illustrated in the figures, according to the example, the head lens 21, 31, 41 of one of the optical groups 2, 3, 4 can be positioned overlapping the rear part of another of said optical groups. Seen from above, as illustrated in FIG. 3, the three optical groups have a geometric configuration in a triangle.

Such a device will find a particular application as a portable device. To this end, and as illustrated in particular according to the example in FIG. 3, this device comprises a casing 6 integrating the three optical groups 2, 3, 4, or even control electronics 8. This casing may also have a face of the casing on which said device 1 can rest on a horizontal surface while positioning said imaginary rotation axis 5 vertically. In this position, the head lenses 21, 31, 41 of the optical groups 2, 3, 4 can be oriented upwards.

The portable device can thus integrate the control electronics 8 provided internally to the casing 6, which can advantageously be positioned below said optical groups when the device 1 is resting on said horizontal surface by means of said face 7 of the casing. These control electronics may have a memory for storing the images taken by said optical groups 2, 3, 4, or even be supplied by a power source such as cells or battery integrated in the casing.

The device may also have a connection, such as in particular a USB connection, for transmitting data and in particular downloading data from the electronics of the device according to the invention, to another device such as a computer, or downloading data from such a computer to the control electronics 8 of said device.

Said USB connection may optionally make it possible to supply the device electrically, or even where necessary to recharge the power source (battery) integrated in the casing.

The device may find an application as a webcam in particular during a video conference. For example, by positioning the device at the centre of a table, it will make it possible to view all the participants present around this table.

Naturally other embodiments could have been envisaged by a person skilled in the art without for all that departing from the scope of the invention defined by the following claims.

1. Optical device (1) for image capture, according to a 360° field, by digital stitching of three images comprising three lenses (2, 3, 4) with a longitudinal axis (20, 30, 40) for the respective acquisitions of said three images, each optical group (2, 3, 4) having a head lens (21, 31, 41) followed, on the same optical axis (20, 30, 40) of said optical group, by several lenses (211, 311, 411) in order to project the rays transmitted to an image sensor (22, 32, 42), said three optical groups (2, 3, 4) being entangled together about an imaginary rotation axis (5) for them, and in which, in the direction of said imaginary rotation axis (5), the optical groups are positioned overlapping in a triangular geometric configuration, the longitudinal axis (20, 30, 40) of each optical group being inclined with respect to a plane orthogonal to said imaginary rotation axis so as to enable said optical groups to be entangled.

2. Device according to claim 1, in which the relative positions of the three optical groups (2, 3, 4) are obtained by successive rotations through 120°, on said imaginary rotation axis (5).

3. Device according to claim 1, in which the angle of inclination between the longitudinal axis (20, 30, 40) of each optical group (2, 3, 4) and said plane orthogonal to said imaginary rotation axis (5) is between 15° and 30°.

4. Device according to claim 1, in which the head lens (21, 31, 41) of one of the optical groups (2, 3, 4) is positioned overlapping the rear part of another of said optical groups (2, 3, 4).

5. Device according to claim 1, portable, comprising a casing (6) integrating the three optical groups (2, 3, 4) as well as control electronics (8).

6. Device according to claim 5, having a face (7) of said casing on which said device (1) can rest on a horizontal surface while positioning said imaginary rotary axis (5) vertically, said head lens (21, 31, 41) of the optical groups (2, 3, 4) oriented upwards.

7. Device according to claim 6, in which the control electronics (8) are positioned below said optical groups (2, 3, 4) when the device (1) is resting on said horizontal surface by means of said face (7) of said casing.

8. Device according to claim 5, in which the control electronics (8) have a memory for storing the images taken by said optical groups (2, 3, 4).

9. Device according to claim 5, in which the casing integrates a power supply source.

10. Device according claim 5, having a connection for data transmission.

11. A method for obtaining 360° images comprising digital stitching of three images acquired by the device according to claim 1, said three images respectively corresponding to the three optical groups (2, 3, 4) of said device (1).

12. A webcam comprising the device of according to claim 1.
